(19) United States
(12) Patent Application Publication
(10) Pub. No.: US 2022/0197487 A1
(43) Pub. Date: Jun. 23, 2022

(54) VIEW MODE CHANGE DEVICE USING TOUCH PATTERN INPUT AND METHOD THEREFOR

(71) Applicant: Ja Beom KOO, Seoul (KR)

(72) Inventor: Ja Beom KOO, Seoul (KR)

(21) Appl. No.: 17/606,085

(22) PCT Filed: Jun. 19, 2020
(86) PCT No.: PCT/KR2020/007942

§ 371 Date: Oct. 25, 2021

(30) Foreign Application Priority Data
Jun. 19, 2019 (KR) 10-2019-0072741
Aug. 21, 2019 (KR) 10-2019-0102069

(51) Int. Cl. G06F 3/04845; G06F 3/0488; G06F 1/16; H04M 1/72454

(52) U.S. Cl. CPC G06F 3/04845; G06F 3/0488; G06F 2200/1614; H04M 1/72454; G06F 1/1613

(57) ABSTRACT

The present invention relates to a view mode change device for rotating or fixing a displayed content by using a specific pattern according to simultaneous movements of a first touch and a second touch, and a method therefor, the view mode change device comprising a touch panel; a pattern sensing unit for sensing a first touch with a specific time duration in one area of the touch panel, sensing a second touch with a specific time duration in the other area of the touch panel, and sensing a specific pattern according to simultaneous movements of the first touch and the second touch; and a screen control unit for rotating or fixing, by the specific pattern, a content being displayed on the touch panel.

### TECHNICAL FIELD

The present invention relates to a view mode change device using a touch pattern input and a method thereof, and more particularly, to a device for rotating or fixing displayed content by a specific pattern according to a simultaneous movement of a first touch and a second touch and a method thereof.

### RELATED ART

A gyro sensor refers to a concept of using a dynamic motion of a rotating object and is a technique used for position measurement and direction setting. The gyro sensor is mainly used for a smartphone.

Users set a setting to turn OFF a gyro sensor included in a smartphone or lock a portrait view. In the case of setting the gyro sensor to “OFF” or setting the portrait view to be locked, content shown, that is, displayed on a smartphone does not rotate although the smartphone is placed horizontally.

Here, if a user considers that a landscape view is appropriate while viewing content, such as a photo, a video, and a text, the user needs to turn ON the gyro sensor or unlock the portrait view using a settings menu or a simple settings menu included in the smartphone.

It causes inconvenience, such as having to stop a video being played or pause an application.

### DETAILED DESCRIPTION

### Subject

An objective of the present invention provides technology for locking or unlocking a portrait view by controlling a gyro sensor to be turned ON or OFF without changing a setting using a specific touch pattern input.

### Solution

A view mode change device using a touch pattern input according to an example embodiment includes a touch panel; a pattern detector configured to detect a first touch for a specific time duration in one area of the touch panel, to detect a second touch for a specific time duration in another area of the touch panel, and to detect a specific pattern according to a simultaneous movement of the first touch and the second touch; and a screen controller configured to rotate or fix content displayed on the touch panel by the specific pattern.

The pattern detector may be configured to detect a double touch of the first touch and the second touch by a portion of a body of a user on the touch panel.

The pattern detector may be configured to detect the specific pattern based on a simultaneous movement by rotation of the first touch and the second touch that are detected being spaced apart by a predetermined distance or more within a range of the touch panel.

The pattern detector may be configured to detect the specific pattern according to a simultaneous movement of the first touch and the second touch generated in a central portion of the content displayed on the touch panel.

The pattern detector may be configured to detect the specific pattern of forward rotation according to a simultaneous movement of the first touch and the second touch that move clockwise or to detect the specific pattern of reverse rotation according to a simultaneous movement of the first touch and the second touch that move counterclockwise.

The screen controller may be configured to, when the forward rotation is detected by the pattern detector, turn ON a gyro sensor in a mobile device to unlock a portrait view and rotate the content displayed on the touch panel.

The screen controller may be configured to, when the reverse rotation is detected by the pattern detector, turn OFF the gyro sensor in the mobile device to lock the portrait view and fix the content displayed on the touch panel in the portrait view.

The screen controller may be configured to control rotation or fixation of the displayed content by the specific pattern only in a pre-specified application.

The screen controller may be configured to control rotation or fixation of the content by the specific pattern only when a video or image related application is executed.

An operation method of a view mode change device using a touch pattern input according to an example embodiment includes detecting a first touch for a specific time duration in one area of a touch panel and detecting a second touch for a specific time duration in another area of the touch panel; detecting a specific pattern according to a simultaneous movement of the first touch and the second touch; and rotating or fixing content displayed on the touch panel by the specific pattern.

The detecting of the first touch and the second touch may include detecting a double touch of the first touch and the second touch by a portion of a body of a user on the touch panel.

The detecting of the specific pattern may include detecting the specific pattern based on a simultaneous movement by rotation of the first touch and the second touch that are detected being spaced apart by a predetermined distance or more within a range of the touch panel.

The detecting of the specific pattern may include detecting the specific pattern of forward rotation according to a simultaneous movement of the first touch and the second touch that move clockwise or detecting the specific pattern of reverse rotation according to a simultaneous movement of the first touch and the second touch that move counterclockwise.

The rotating or the fixing of the content displayed on the touch panel may include, when the forward rotation is detected, turning ON a gyro sensor in a mobile device to unlock a portrait view and rotate the content displayed on the touch panel, and, when the reverse rotation is detected, turning OFF the gyro sensor in the mobile device to lock the portrait view and fix the content displayed on the touch panel in the portrait view.

The rotating or the fixing of the content displayed on the touch panel may include rotating or fixing the displayed content by the specific pattern only in a pre-specified application.

Also, a view mode change device using a touch pattern input according to an example embodiment includes a touch panel and detects a first touch (e.g., a touch on a palm face) for a specific time duration in one area of the touch panel and rotates or fixes content displayed on the touch panel based on a duration time of the detected first touch.

Also, a view mode change device using a touch pattern input according to an example embodiment includes a touch panel and detects a movement of a first touch (e.g., a touch on a palm face) in one area of the touch panel and rotates or fixes content displayed on the touch panel based on the detected movement of the first touch. Here, the movement includes moving the palm face up after a contact on the palm face and moving the palm face down after a contact on the palm face.

Also, a view mode change device using a touch pattern input according to an example embodiment includes a touch panel and detects a first touch (e.g., preset fingers or a preset number of fingers) for a specific time duration in one area of the touch panel and rotates or fixes content displayed on the touch panel based on a duration time of the detected first touch.

Also, a view mode change device using a touch pattern input according to an example embodiment includes a touch panel and detects a movement of a first touch (e.g., preset fingers or a preset number of fingers) in one area of the touch panel and rotates or fixes content displayed on the touch panel based on the detected movement of the first touch. Here, the movement includes the preset fingers or the preset number of fingers moving up, moving down, moving left, and moving right after a touch thereof.

### Effect

According to example embodiments, it is possible to lock or unlock a portrait view by detecting a specific pattern according to a simultaneous movement of a first touch and a second touch on a touch panel and by controlling a gyro sensor to be turned ON or OFF without changing a setting.

Also, according to example embodiments, it is possible to lock or unlock a portrait view of displayed content without pausing a running application by turning ON or OFF a gyro sensor according to a forward rotation or a reverse rotation of a first touch and a second touch.

Also, according to example embodiments, it is possible to minimize a malfunction by a carelessness of a user by controlling rotation or fixation of content by a specific pattern only in a pre-specified application.

### BRIEF DESCRIPTION OF DRAWINGS

FIG. 1 is a diagram illustrating a configuration of a view mode change device using a touch pattern input according to an example embodiment.

FIGS. 2 and 3 illustrate examples of a specific pattern according to a simultaneous movement of a first touch and a second touch according to an example embodiment.

FIGS. 4A to 4C illustrate examples of rotating or fixing displayed content by a specific pattern according to an example embodiment.

FIGS. 5 to 7 illustrate examples of a specific pattern according to an individual movement of a third touch and a fourth touch according to an example embodiment.

FIG. 8 illustrates an example of a specific pattern according to a variety of movement according to another example embodiment.

FIG. 9 is a flowchart illustrating a view mode change method using a touch pattern input according to an example embodiment.

### BEST MODE

Hereinafter, example embodiments are described in detail with reference to the accompanying drawings. However, the present invention is not limited to or restricted by the example embodiments. Also, like reference numerals in the respective drawings refer to like elements.

Also, terminologies used herein refer to terminologies used to appropriately represent example embodiments and may vary depending on the intent of a viewer and an operator or custom of a field to which the present invention pertains. Accordingly, the definition of the terminologies should be made based on the contents throughout the specification.

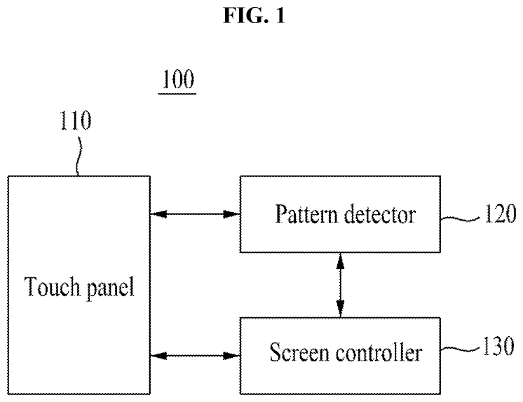

FIG. 1 is a diagram illustrating a configuration of a view mode change device using a touch pattern input according to an example embodiment.

Referring to FIG. 1, the view mode change device using the touch pattern input according to an example embodiment rotates or fixes displayed content by a specific pattern according to a simultaneous movement of a first touch and a second touch.

To this end, a view mode change device 100 using a touch pattern input according to an example embodiment includes a touch panel 110, a pattern detector 120, and a screen controller 130.

The touch panel 110 relates to detecting a touch and corresponds to a transparent panel capable of controlling a device by directly pressing a place in which a text or a picture is displayed in combination with a cathode ray tube (CRT) or a liquid crystal display (LCD). The touch panel 110 may include an optical scheme using an infrared ray, a transparent electrode scheme using a contact point of a transparent conductive film, a capacitive scheme of detecting a change in capacitance, and a scheme of sensing a position from a distribution of force over a pressure sensor provided around a panel.

The touch panel 110 may include a display unit (not shown), and the display unit may be implemented as a display device that includes a CRT, an LCD, and the like, and may be implemented including the touch panel.

The touch panel 110 detects a touch in a mobile device of a user and displays content. The mobile device may be at least one terminal among a smartphone, a desktop personal computer (PC), a mobile terminal, a personal digital assistant (PDA), a laptop computer, and a tablet PC, and may be a device that includes a display of a touch screen type (i.e., the touch panel 110) capable of receiving information according to a selection input of an administrator and the user through an application and performing an operation of a predetermined function set through a screen that includes a touch-detection area and may be a device that includes at least one physical button or virtual button. Therefore, a type and a shape of the mobile device are not limited thereto.

The pattern detector 120 detects a first touch for a specific time duration in one area of the touch panel 110, detects a second touch for a specific time duration in another area of the touch panel 110, and detects a specific pattern according to a simultaneous movement of the first touch and the second touch. Here, the simultaneous movement represents that the first touch and the second touch are simultaneously shifted and moved by the user and may be basically performed with two fingers of the user.

The pattern detector 120 may detect the first touch and the second touch based on touch data received by the touch panel 110. Here, the first touch and the second touch may correspond to touches using two fingers of the user and may be touches by a pausing operation for a specific time duration. The first touch and the second touch refer to positions detected in one area and the other area of the touch panel 110 and a distance between the first touch and the second touch is not limited.

The pattern detector 120 may detect a double touch of the first touch and the second touch by a portion of a body of the user on the touch panel 110. For example, if the user touches a thumb and an index finger on the touch panel 110, the pattern detector 120 may detect the double touch of the first touch and the second touch by detecting the thumb of the user as the first touch and by detecting the index finger of the user as the second touch.

As described above, according to the first touch and the second touch detected as the double touch, the pattern detector 120 may detect a specific pattern based on a simultaneous movement by rotation of the first touch and the second touch that are detected being spaced apart by a predetermined distance or more within a range of the touch panel 110. In detail, the first touch and the second touch on the touch panel 110 may form the specific pattern by a movement of the user. For example, the user may form a specific pattern by positioning the first touch of the thumb and the second touch of the index finger on the touch panel 110 and then applying a simultaneous movement while rotating the first touch and the second touch in a forward direction or a reverse direction.

The pattern detector 120 may detect a specific pattern of forward rotation according to a simultaneous movement of the first touch and the second touch that move clockwise or may detect a specific pattern of reverse rotation according to a simultaneous movement of the first touch and the second touch that move counterclockwise. For example, if the user places the first touch of the thumb and the second touch of the index finger on the touch panel 110 and then simultaneously rotates the first touch and the second touch clockwise, the pattern detector 120 may detect the specific pattern of forward rotation according to the simultaneous movement that moves clockwise. Also, if the user places the first touch of the thumb and the second touch of the index finger on the touch panel 110 and then simultaneously rotates the first touch and the second touch counterclockwise, the pattern detector 120 may detect the specific pattern of reverse rotation according to the simultaneous movement that moves counterclockwise.

Here, the pattern detector 120 may detect a specific pattern according to a simultaneous movement of the first touch and the second touch generated in a central portion of the content displayed on the touch panel 110. The view mode change device 100 is based on detecting only a specific pattern generated in a central portion of the touch panel 110. The central portion may be the entire area excluding non-central portions of both sides of the touch panel 110 and thus, a width and an area thereof are not limited.

The pattern detector 120 of the view mode change device 100 according to an example embodiment may detect a specific pattern that is generated in a non-central portion of the touch panel 110. In detail, the pattern detector 120 may individually detect single touches generated in non-central portions of both sides excluding the central portion of the touch panel 110, that is, a third touch and a fourth touch, and may detect an individual movement of each of the third touch and the fourth touch. Here, the individual movement may represent that the user individually shifts and moves the third touch or the fourth touch and may be performed with a single touch alone using one finger of the user.

As one example embodiment, if the user positions the third touch that is a single touch on an upper side of a right non-central portion and shifts the third touch from an upper side to a lower side using a single finger, the pattern detector 120 may detect a specific pattern of a downward movement of the third touch.

As another example embodiment, if the user positions the fourth touch that is a single touch on a lower side of a left non-central portion and shifts the fourth touch from the lower side to the upper side using a single finger, the pattern detector 120 may detect a specific pattern of an upward movement of the fourth touch.

The screen controller 130 rotates or fixes the content displayed on the touch panel 110 by the specific pattern.

As described above, when the forward rotation that moves clockwise is detected by the pattern detector 120, the screen controller 130 may turn ON the gyro sensor in the mobile device to unlock a portrait view and horizontally rotate the content displayed on the touch panel 110. Also, when the reverse rotation that moves counterclockwise is detected by the pattern detector 120, the screen controller 130 may turn OFF the gyro sensor in the mobile device to lock the portrait view and fix the content displayed on the touch panel 110 in the portrait view.

Here, in the case of unlocking or locking the portrait view by turning ON or OFF the gyro sensor by the specific pattern, the screen controller 130 of the view mode change device 100 may provide notification information about an operation of the gyro sensor to the user through a text of “sensor ON” or “sensor OFF” on one area of the touch panel 110. Depending on example embodiments, the text may be output on one area that does not interfere with the displayed content and may be output with any one notification function among an alert sound, an alert light, and a vibration. Herein, the present invention provides the user with the aforementioned text or notification function for the operation of the gyro sensor, thereby minimizing a functional error unintended by the user. Here, without being limited to the aforementioned example, any type of emoticons, contents, or texts that notify ON or OFF of the gyro sensor may be applied as the aforementioned text.

Further, after unlocking the portrait view by turning ON the gyro sensor by forward rotation, the screen controller 130 of the view mode change device 100 according to an example embodiment may control the displayed content to be fixed to the right or to the left according to the specific pattern of the downward movement or the specific pattern of the upward movement detected by the pattern detector 120.

In the case of unlocking the portrait view by turning ON the gyro sensor, the displayed content is shifted as right full content or left full content according to a movement of the mobile device. That is, since the gyro sensor in the mobile device operates finely according to a movement of the user, there is an inconvenience in that the displayed content is changed to the right full content or the left full content according to a movement of the mobile device regardless of the intent of the user.

Therefore, when the gyro sensor is turned ON to unlock the portrait view by forward rotation according to a simultaneous movement of the first touch and the second touch, the view mode change device 100 according to an example embodiment may detect a specific pattern of a downward movement of the third touch that moves from an upper side to a lower side in a right non-central portion or a specific pattern of an upward movement of the fourth touch that moves from the lower side to the upper side in a left non-central portion and may fix the displayed content to the right or the left.

The following description is made based on an example in which the gyro sensor is turned ON to unlock the portrait view.

As an example embodiment, when the user shifts the third touch from the upper side to the lower side in the right non-central portion of the touch panel 110 using a finger of the user, the screen controller 130 may detect the specific pattern of the downward movement of the third touch and may fix, to the right, the displayed content of which the portrait view is unlocked. Here, fixing to the right may represent fixing the content in a state in which a speaker and camera portion, that is, an upper end of the mobile device is present on the left and a microphone portion, that is, a lower end of the mobile device is present on the right.

As another example embodiment, when the user shifts the fourth touch from the lower side to the upper side in the left non-central portion of the touch panel 110 using a finger of the user, the screen controller 130 may detect the specific pattern of the upward movement of the fourth touch and may fix, to the left, the displayed content of which the portrait view is unlocked. Here, fixing to the left may represent fixing the content in a state in which the speaker and camera portion, that is, the upper end of the mobile device is present on the right and the microphone portion, that is, the lower end of the mobile device is present on the left.

Here, fixing to the right or fixing to the left described herein is not limited to the aforementioned description. The view mode change device 100 according to an example embodiment may detect a specific pattern according to an individual movement of the third touch or the fourth touch and may fix the content in a single direction when the gyro sensor is turned ON.

The screen controller 130 of the view mode change device 100 according to an example embodiment may control rotation or fixation by a specific pattern only in the content displayed on the touch panel 110 through a pre-specified application.

For example, only when a video or image related application is executed, the screen controller 130 may turn ON the gyro sensor by a specific pattern to unlock the portrait view or may turn OFF the gyro sensor to lock the portrait view and may set the displayed content to be fixed to the right or to the left. Here, when an application related to a messenger or social network services/sites (SNS) is executed, the screen controller 130 may perform only a function of turning OFF the gyro sensor by the specific pattern to lock the portrait view.

That is, the view mode change device 100 according to an example embodiment may control rotation or fixation of content according to a type of application that runs in the mobile device, and when the application related to the messenger or SNS is executed, may perform only the function of turning OFF the gyro sensor to lock the portrait view.

Depending on example embodiments, an application capable of controlling rotation or fixation of content by a specific pattern may be set according to a selection input from the user and may be differently set according to a website.

In basic, the view mode change device 100 according to an example embodiment may detect a movement of the first touch and the second touch, which are detected through the pattern detector 120, that simultaneously rotate in a forward direction or a reverse direction and rotate or fix the displayed content through the screen controller 130. Here, the view mode change device 100 according to an example embodiment may perform a simple gyro sensor function, that is, a function of rotating or fixing the displayed content through various example embodiments in addition to the aforementioned method.

As a first example embodiment, when the user places two fingers on the touch panel 110 and rotates the other finger in a forward direction or a reverse direction with one finger as an axis, the view mode change device 100 according to an example embodiment may rotate or fix the displayed content by detecting the first touch and the second touch and by detecting a movement of the other touch that rotates in the forward direction or the reverse direction with one of the first touch and the second touch as an axis.

As a second example embodiment, when the user places a palm or a plurality of fingers on the touch panel 110 and then rotates the same in the forward direction or the reverse direction, the view mode change device 100 may rotate or fix the displayed content by detecting the palm or the plurality of fingers and by detecting a movement of a detected large-area touch or a plurality of touches that moves in the forward direction or the reverse direction.

As a third example embodiment, when the user touches a finger more than once on the touch panel 110, the view mode change device 100 according to an example embodiment may rotate or fix the displayed content by detecting a single touch multiple times.

As a fourth example embodiment, when the user draws a circle on the touch panel 110 with a single touch of a finger, the view mode change device 100 according to an example embodiment may rotate or fix the displayed content by detecting the single touch and by detecting a movement of the detected touch that rotates in the forward direction or the reverse direction.

As a fifth example embodiment, when the user makes a touch using the palm or the plurality of fingers on the touch panel 110 for a predetermined time duration or more, the view mode change device 100 according to an example embodiment may detect the touch using the palm or the plurality of fingers and may rotate or fix the displayed content if the detected touch is maintained for the predetermined time duration or more.

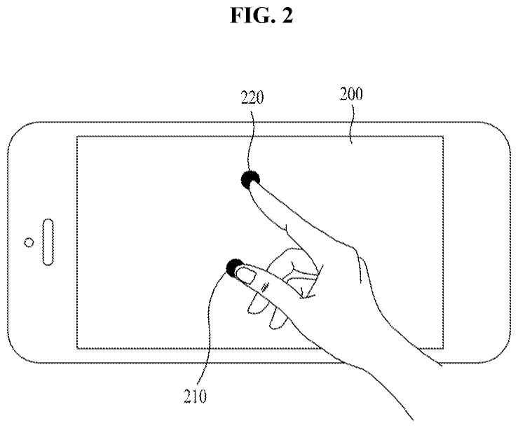

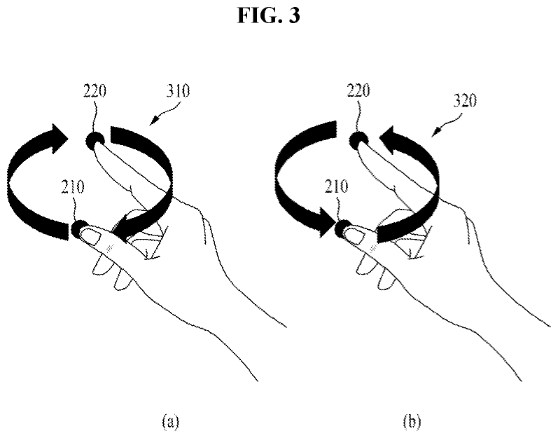

FIGS. 2 and 3 illustrate examples of a specific pattern according to a simultaneous movement of a first touch and a second touch according to an example embodiment.

In detail, FIG. 2 illustrates an example of a first touch and a second touch on a touch panel according to an example embodiment, and FIG. 3 illustrates an example of a specific pattern of forward rotation and reverse rotation according to an example embodiment.

Referring to FIG. 2, a user touches two fingers on a touch panel 200 using a thumb and an index finger and a view mode change device using a touch pattern input according to an example embodiment may detect a first touch 210 and a second touch 220 on the touch panel 200.

Here, although the first touch 210 and the second touch 220 are positioned with a predetermined interval therebetween, a length of a straight line that connects the first touch 210 and the second touch 220 is not limited.

Referring to FIG. 3, (a) of FIG. 3 illustrates a specific pattern of forward rotation according to a simultaneous movement of the first touch 210 and the second touch 220 that move clockwise, and (b) of FIG. 3 illustrates a specific pattern of reverse rotation according to a simultaneous movement of the first touch 210 and the second touch 220 that move counterclockwise.

Referring to (a) of FIG. 3, when the first touch 210 and the second touch 220 simultaneously move clockwise on the touch panel 200, the view mode change device using the touch pattern input according to an example embodiment may rotate content displayed on the touch panel 200 by detecting a specific pattern 310 of forward rotation and by turning ON a gyro sensor in a mobile device.

Referring to (b) of FIG. 3, when the first touch 210 and the second touch 220 simultaneously move counterclockwise on the touch panel 200, the view mode change device using the touch pattern input according to an example embodiment may fix the content displayed on the touch panel 200 to a portrait view by detecting a specific pattern 320 of reverse rotation and by turning OFF the gyro sensor in the mobile device to lock the portrait view.

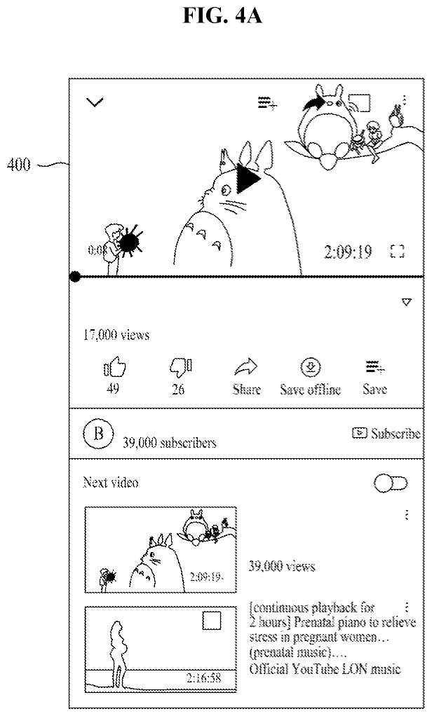

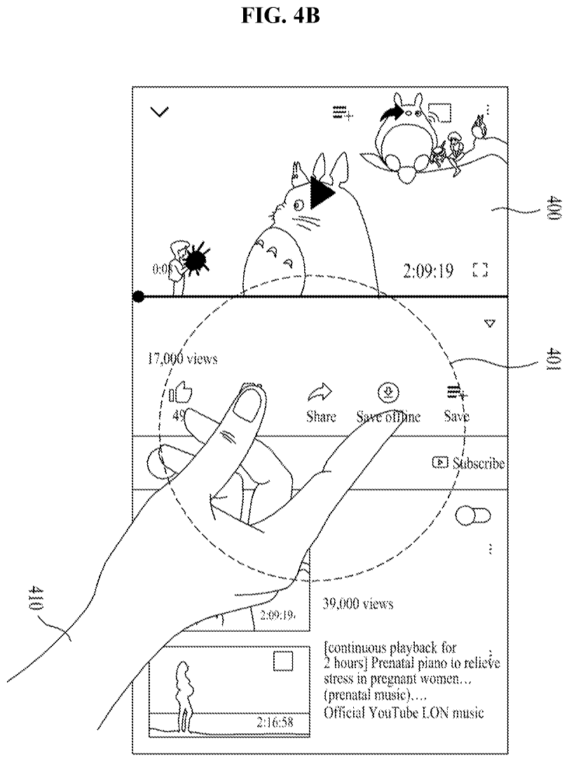

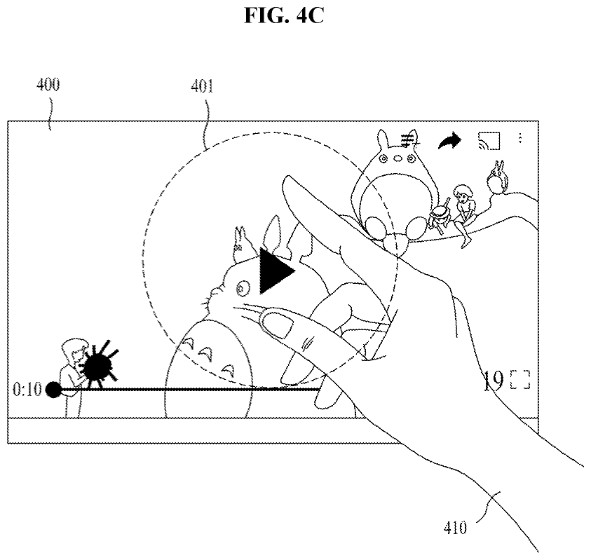

FIGS. 4A to 4C illustrate examples of rotating or fixing displayed content by a specific pattern according to an example embodiment.

A view mode change device using a touch pattern input according to an example embodiment may detect a specific pattern according to a simultaneous movement of a first touch and a second touch generated in a central portion of content displayed on a touch panel.

Only when a specific pattern according to a simultaneous movement of the first touch and the second touch by a user 410 is generated in a central portion 401 of a touch panel 400, the view mode change device using the touch pattern input according to an example embodiment may detect the specific pattern and may rotate or fix content displayed on the touch panel 400 by the specific pattern.

As an example, if the user 410 regards that a landscape view is appropriate while viewing a video on YouTube in a state in which a gyro sensor of a mobile device is turned OFF and a portrait view is locked as shown in FIG. 4A, the user 410 generates a simultaneous movement of the first touch and the second touch using fingers in the central portion 401 of the touch panel 400 in a state in which the mobile device is horizontally placed as shown in FIG. 4B.

Therefore, the view mode change device using the touch pattern input according to an example embodiment may turn ON the gyro sensor or unlock the portrait view by detecting a specific pattern of forward rotation according to the simultaneous movement of the first touch and the second touch by the user 410 in the central portion 401.

As another example, if the user 410 regards that the portrait view is appropriate while viewing a video on YouTube in a state in which the gyro sensor of the mobile device is turned ON and the portrait view is unlocked as shown in FIG. 4C, the user 410 generates a simultaneous movement of the first touch and the second touch using fingers in the central portion 401 of the touch panel 400.

The view mode change device using the touch pattern input according to an example embodiment may turn OFF the gyro sensor or lock the portrait view by detecting a specific pattern of reverse rotation according to the simultaneous movement of the first touch and the second touch by the user 410 in the central portion 401.

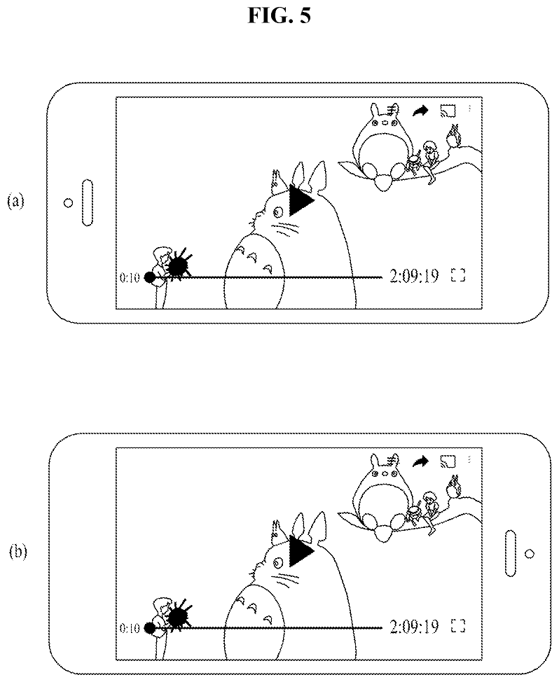

FIGS. 5 to 7 illustrate examples of a specific pattern according to an individual movement of a third touch and a fourth touch according to an example embodiment.

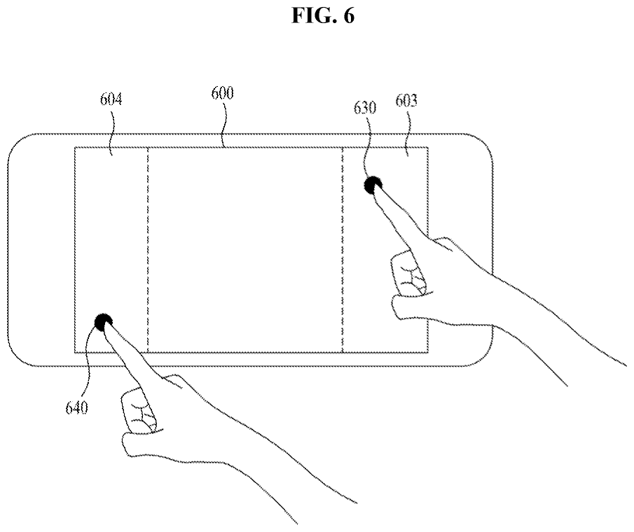

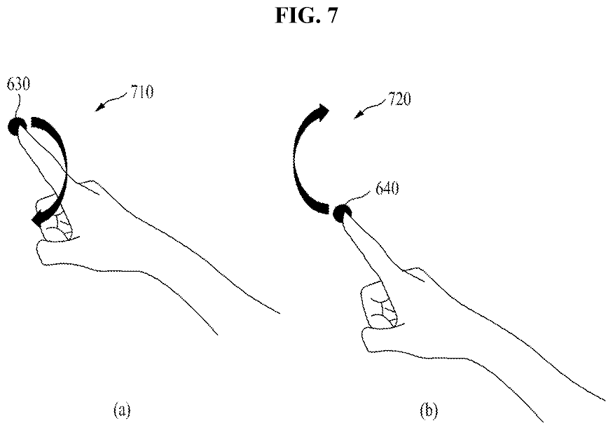

In detail, FIG. 5 illustrates an example of fixing to the right and fixing to the left according to an example embodiment, FIG. 6 illustrates an example of a third touch and a fourth touch on a touch panel according to an example embodiment, and FIG. 7 illustrates an example of a specific pattern of a downward movement and an upward movement according to an example embodiment.

In the case of unlocking a portrait view by turning ON a gyro sensor, displayed content is shifted as right full content or left full content according to a movement of a mobile device. That is, since the gyro sensor in the mobile device operates finely according to a movement of a user, there is an inconvenience in that the displayed convent is changed to the right full content ((a) of FIG. 5) or the left full content ((b) of FIG. 5) according to a movement of the mobile device regardless of the intent of the user.

Therefore, when the gyro sensor is turned ON to unlock the portrait view by forward rotation according to a simultaneous movement of the first touch and the second touch, the view mode change device according to an example embodiment may detect a specific pattern 710 of a downward movement of a third touch 630 that moves from an upper side to a lower side in a right non-central portion 603 or a specific pattern 720 of a fourth touch 640 that moves from the lower side to the upper side in a left non-central portion 604 and may fix the displayed content to the right or to the left.

Describing with reference to FIGS. 5 to 7, as an example embodiment, when the user shifts the third touch 630 from the upper side to the lower side in the right non-central portion 603 of a touch panel 600 using a finger of the user, the view mode change device according to an example embodiment may detect the specific pattern 710 of the downward movement of the third touch 630 and may fix, to the right, the displayed content of which the portrait view is unlocked. Here, fixing to the right may represent fixing the content in a state in which a speaker and camera portion, that is, an upper end of the mobile device is present on the left and a microphone portion, that is, a lower end of the mobile device is present on the right as shown in (a) of FIG. 5.

As another example embodiment, when the user shifts the fourth touch 640 from the lower side to the upper side in the left non-central portion 604 of the touch panel 600 using a finger of the user, the view mode change device according to an example embodiment may detect the specific pattern 720 of the upward movement of the fourth touch 640 and may fix, to the left, the displayed content of which the portrait view is unlocked. Here, fixing to the left may represent fixing the content in a state in which the speaker and camera portion, that is, the upper end of the mobile device is present on the right and the microphone portion, that is, the lower end of the mobile device is present on the left as shown in (b) of FIG. 5.

Here, fixing to the right or fixing to the left described herein is not limited to the aforementioned description. The view mode change device according to an example embodiment may detect a specific pattern according to an individual movement of the third touch 630 or the fourth touch 640 and may fix the content in a single direction when the gyro sensor is turned ON.

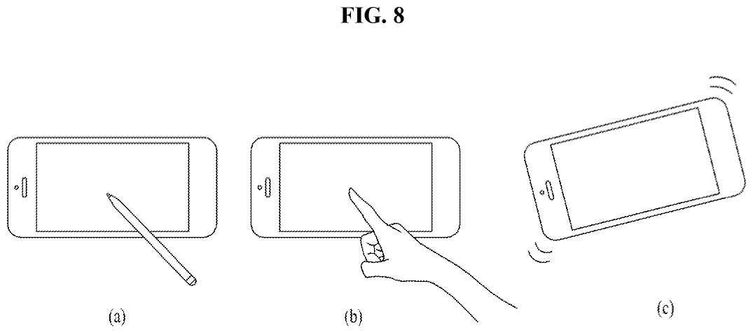

FIG. 8 illustrates an example of a specific pattern according to a variety of movement according to another example embodiment.

Referring to (a) of FIG. 8, a view mode change device according to another example embodiment may turn ON or OFF a gyro sensor according to a specific pattern drawn on a touch panel with a touch pen. For example, when a user draws a clockwise circle or a counterclockwise circle on the touch panel with the touch pen in a state in which a mobile device is placed horizontally or vertically, the view mode change device according to another example may detect the clockwise circle and turn ON the gyro sensor to unlock a portrait view or may detect the counterclockwise circle and turn OFF the gyro sensor to lock the portrait view.

Referring to (b) of FIG. 8, the view mode change device according to another example embodiment may turn ON or OFF the gyro sensor based on a specific number of times the user touches the touch panel using a touch pen or a finger. For example, if the user touches the touch panel a specific number of times more than once using the touch pen or the finger in a state in which the mobile device is placed horizontally or vertically, the view mode change device according to another example embodiment may detect two touches and turn ON the gyro sensor to unlock the portrait view and may detect three touches and turn OFF the gyro sensor to lock the portrait view. Also, if three touches are repeated, the view mode change device may alternately control ON and OFF of the gyro sensor according to consecutive repetitions of three touches.

Referring to (c) of FIG. 8, the view mode change device according to another example embodiment may turn ON or OFF the gyro sensor according to a specific number of times by shaking the mobile device or applying a slight impact thereto.

For example, when the user shakes the mobile device or applies a slight impact thereto at least once or a specific number of times in a state in which the mobile device is placed horizontally, the view mode change device according to another example embodiment may unlock the portrait view by turning ON the gyro sensor. On the contrary, when the user shakes the mobile device at least once or a specific number of times or applies a slight impact thereto in a state in which the mobile device is placed vertically, the view mode change device may lock the portrait view by turning ON the gyro sensor.

As another example, when the user shakes the mobile device or applies a slight impact thereto at least once or a specific number of times regardless of a vertical or horizontal position of the mobile device, the view mode change device according to another example embodiment may repeatedly control ON and OFF of the gyro sensor. For example, when the user applies an impact to the mobile device twice, the view mode change device may turn ON the gyro sensor, and when the user applies an impact twice again, may turn OFF the gyro sensor.

As still another example, when the user shakes the mobile device or applies a slight impact thereto at least once or a specific number of times regardless of a vertical or horizontal position of the mobile device, the view mode change device according to another example embodiment may detect two impacts and turn ON the gyro sensor to unlock the portrait view and may detect three impacts and turn OFF the gyro sensor to lock the portrait view. Also, if the three impacts are repeated, the view mode change device may alternately control ON and OFF of the gyro sensor according to consecutive repetitions of three impacts.

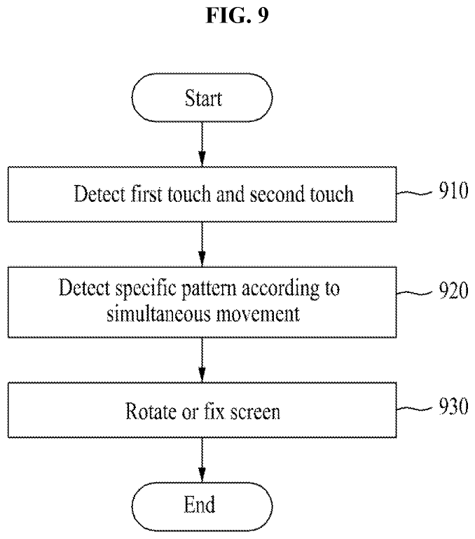

FIG. 9 is a flowchart illustrating a view mode change method using a touch pattern input according to an example embodiment.

The method of FIG. 9 is performed by the view mode change device using the touch pattern input according to an example embodiment of FIG. 1.

Referring to FIG. 9, operation 910 detects a first touch for a specific time duration in one area of a touch panel and detects a second touch for a specific time duration in another area of the touch panel.

Operation 910 may detect a double touch of the first touch and the second touch by a portion of a body of a user on the touch panel based on touch data received by the touch panel. For example, if the user touches the touch panel with a thumb and an index finger, operation 910 may detect a double touch of the first touch and the second touch by detecting the thumb of the user as the first touch and detecting the index finger of the user as the second touch.

Operation 920 detects a specific pattern according to a simultaneous movement of the first touch and the second touch.

Operation 920 may detect the specific pattern based on a simultaneous movement by rotation of the first touch and the second touch that are detected being spaced apart by a predetermined distance or more within a range of the touch panel.

For example, operation 920 may detect a specific pattern of forward rotation according to a simultaneous movement of the first touch and the second touch that move clockwise or may detect a specific pattern of reverse rotation according to a simultaneous movement of the first touch and the second touch that move counterclockwise.

Operation 920 of the view mode change method according to an example embodiment may detect a specific pattern that is generated in a non-central portion of the touch panel. In detail, operation 920 may individually detect single touches generated in non-central portions of both sides excluding the central portion of the touch panel, that is, a third touch and a fourth touch, and may detect an individual movement of each of the third touch and the fourth touch.

As one example embodiment, if the user positions the third touch that is a single touch on an upper side of a right non-central portion and shifts the third touch from an upper side to a lower side using a single finger, operation 920 may detect a specific pattern of a downward movement of the third touch.

As another example embodiment, if the user positions the fourth touch that is a single touch on a lower side of a left non-central portion and shifts the fourth touch from the lower side to the upper side using a single finger, operation 920 may detect a specific pattern of an upward movement of the fourth touch.

Operation 930 rotates or fixes the content displayed on the touch panel by the specific pattern.

When the forward rotation is detected, operation 930 may turn ON the gyro sensor in the mobile device to unlock a portrait view and rotate the content displayed on the touch panel. Also, when the reverse rotation is detected, operation 930 may turn OFF the gyro sensor in the mobile device to lock the portrait view and fix the content displayed on the touch panel in the portrait view.

As described above, after unlocking the portrait view by turning ON the gyro sensor by the forward rotation, operation 930 of the view mode change method according to an example embodiment may detect the specific pattern of the downward movement or the specific pattern of the upward movement detected by operation 920 and may control the content displayed on the touch panel to be fixed to the right or to the left.

Operation 930 may rotate or fix the displayed content by the specific pattern only in a pre-specified application.

For example, only when a video or image related application is executed, operation 930 may turn ON the gyro sensor by a specific pattern to unlock the portrait view or may turn OFF the gyro sensor to lock the portrait view and may set the displayed content to be fixed to the right or to the left. Here, when an application related to a messenger or SNS is executed, operation 930 may perform only a function of turning OFF the gyro sensor by the specific pattern to lock the portrait view.

Also, a view mode change device using a touch pattern input according to an example embodiment includes a touch panel and detects a first touch (e.g., a touch on a palm face) for a specific time duration in one area of the touch panel and rotates or fixes content displayed on the touch panel based on a duration time of the detected first touch.

Also, a view mode change device using a touch pattern input according to an example embodiment includes a touch panel and detects a movement of a first touch (e.g., a touch on a palm face) in one area of the touch panel and rotates or fixes content displayed on the touch panel based on the detected movement of the first touch. Here, the movement includes moving the palm face up after a contact on the palm face and moving the palm face down after a contact on the palm face.

Also, a view mode change device using a touch pattern input according to an example embodiment includes a touch panel and detects a first touch (e.g., preset fingers or a preset number of fingers) for a specific time duration in one area of the touch panel and rotates or fixes content displayed on the touch panel based on a duration time of the detected first touch.

Also, a view mode change device using a touch pattern input according to an example embodiment includes a touch panel and detects a movement of a first touch (e.g., preset fingers or a preset number of fingers) in one area of the touch panel and rotates or fixes content displayed on the touch panel based on the detected movement of the first touch. Here, the movement includes the preset fingers or the preset number of fingers moving up, moving down, moving left, and moving right after a touch thereof.

### Mode

The apparatuses described herein may be implemented using hardware components, software components, and/or a combination of the hardware components and the software components. For example, the apparatuses and the components described herein may be implemented using one or more general-purpose or special purpose computers, such as, for example, a processor, a controller, an arithmetic logic unit (ALU), a digital signal processor, a microcomputer, a field programmable array (FPA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be permanently or temporarily embodied in any type of machine, component, physical equipment, virtual equipment, a computer storage medium or device, or a signal wave to be transmitted to be interpreted by the processing device or to provide an instruction or data to the processing device. The software also may be distributed over network coupled computer systems so that the software is stored and executed in a distributed fashion. The software and data may be stored by one or more computer readable storage media.

The methods according to the above-described example embodiments may be configured in a form of program instructions performed through various computer devices and recorded in computer-readable media. The program instructions recorded in the media may be specially designed and configured for the example embodiments or may be known and available to those skilled in the computer software art. Examples of the media include magnetic media such as hard disks, floppy disks, and magnetic tapes; optical media such as CD-ROM and DVDs; magneto-optical media such as floptical disks; and hardware devices that are specially configured to store program instructions, such as read-only memory (ROM), random access memory (RAM), flash memory, and the like. Examples of the program instructions include a machine code as produced by a compiler and a high-language code computer-executable using an interpreter. The hard e devices may be configured to operate as at least one software module to perform an operation of the example embodiments, or vice versa.

Although the example embodiments are described with reference to some specific example embodiments and accompanying drawings, it will be apparent to one of ordinary skill in the art that various alterations and modifications in form and details may be made in these example embodiments without departing from the spirit and scope of the claims and their equivalents. For example, suitable results may be achieved if the described techniques are performed in different order and/or if components in a described system, architecture, device, or circuit are coupled or combined in a different manner, or replaced or supplemented by other components or their equivalents.

Therefore, other implementations, other example embodiments, and equivalents of the claims are to be construed as being included in the claims.

What is claimed is:

1. A view mode change device using a touch pattern input, the view mode change device comprising:
a touch panel;
a pattern detector configured to detect a first touch for a specific time duration in one area of the touch panel, to detect a second touch for a specific time duration in another area of the touch panel, and to detect a specific pattern according to a simultaneous movement of the first touch and the second touch; and
a screen controller configured to rotate or fix content displayed on the touch panel by the specific pattern.

2. The view mode change device of claim 1, wherein the pattern detector is configured to detect a double touch of the first touch and the second touch by a portion of a body of a user on the touch panel.

3. The view mode change device of claim 2, wherein the pattern detector is configured to detect the specific pattern based on a simultaneous movement by rotation of the first touch and the second touch that are detected being spaced apart by a predetermined distance or more within a range of the touch panel.

4. The view mode change device of claim 3, wherein the pattern detector is configured to detect the specific pattern according to a simultaneous movement of the first touch and the second touch generated in a central portion of the content displayed on the touch panel.

5. The view mode change device of claim 3, wherein the pattern detector is configured to detect the specific pattern of forward rotation according to a simultaneous movement of the first touch and the second touch that move clockwise or to detect the specific pattern of reverse rotation according to a simultaneous movement of the first touch and the second touch that move counterclockwise.

6. The view mode change device of claim 5, wherein the screen controller is configured to, when the forward rotation is detected by the pattern detector, turn ON a gyro sensor in a mobile device to unlock a portrait view and rotate the content displayed on the touch panel.

7. The view mode change device of claim 6, wherein the screen controller is configured to, when the reverse rotation is detected by the pattern detector, turn OFF the gyro sensor in the mobile device to lock the portrait view and fix the content displayed on the touch panel to the portrait view.

8. The view mode change device of claim 1, wherein the screen controller is configured to control rotation or fixation of the displayed content by the specific pattern only in a pre-specified application.

9. The view mode change device of claim 8, wherein the screen controller is configured to control rotation or fixation of the content by the specific pattern only when a video or image related application is executed.

10. An operation method of a view mode change device using a touch pattern input, the method comprising:
detecting a first touch for a specific time duration in one area of a touch panel and detecting a second touch for a specific time duration in another area of the touch panel;
detecting a specific pattern according to a simultaneous movement of the first touch and the second touch; and
rotating or fixing content displayed on the touch panel by the specific pattern.

11. The method of claim 10, wherein the detecting of the first touch and the second touch comprises detecting a double touch of the first touch and the second touch by a portion of a body of a user on the touch panel.

12. The method of claim 10, wherein the detecting of the specific pattern comprises detecting the specific pattern based on a simultaneous movement by rotation of the first touch and the second touch that are detected being spaced apart by a predetermined distance or more within a range of the touch panel.

13. The method of claim 12, wherein the detecting of the specific pattern comprises detecting the specific pattern of forward rotation according to a simultaneous movement of the first touch and the second touch that move clockwise or detecting the specific pattern of reverse rotation according to a simultaneous movement of the first touch and the second touch that move counterclockwise.

14. The method of claim 13, wherein the rotating or the fixing of the content displayed on the touch panel comprises, when the forward rotation is detected, turning ON a gyro sensor in a mobile device to unlock a portrait view and rotate the content displayed on the touch panel, and, when the reverse rotation is detected, turning OFF the gyro sensor in the mobile device to lock the portrait view and fix the content displayed on the touch panel to the portrait view.

15. The method of claim 10, wherein the rotating or the fixing of the content displayed on the touch panel comprises rotating or fixing the displayed content by the specific pattern only in a pre-specified application.
